(19) United States
(12) Patent Application Publication
(10) Pub. No.: US 2013/0119165 A1
(43) Pub. Date: May 16, 2013

(54) COATING NOZZLE FOR HIGH-VISCOSITY PAINT

(71) Applicants: Ichio Tomita, Nagakute-shi (JP); Kenji Tajima, Nagoya-shi (JP); Mitsuru Nagai, Toyota-shi (JP); Junichi Kawai, Nagakute-shi (JP)

(72) Inventors: Ichio Tomita, Nagakute-shi (JP); Kenji Tajima, Nagoya-shi (JP); Mitsuru Nagai, Toyota-shi (JP); Junichi Kawai, Nagakute-shi (JP)

(73) Assignees: AISIN KAKO KABUSHIKI KAISHA, Toyota-shi (JP); TOYOTA JIDOSHA KABUSHIKI KAISHA, Toyota-shi (JP)

(21) Appl. No.: 13/807,519

(22) PCT Filed: Jun. 29, 2011
(86) PCT No.: PCT/IB2011/002027

§ 371 Date: Dec. 28, 2012

(30) Foreign Application Priority Data
Jun. 29, 2010 (JP) 2010-148293

(51) Int. Cl. B05B 1/04

(52) U.S. Cl. CPC B05B 1/044
USPC 239/567; 239/597

(57) ABSTRACT

A coating nozzle for a high-viscosity paint is equipped with an introduction passage, an inner space, and a nozzle slit, which communicate with one another, and sprays a coating body with the high-viscosity paint from the nozzle slit in a radial direction. The nozzle slit is constructed in a sectional shape having a predetermined angle in a plan view. When the nozzle slit is regarded as having the sectional shape, an arc of the sectional shaped nozzle slit serves as a nozzle slit outlet. The nozzle slit outlet has a nozzle slit outlet width equal to or larger than 35 mm and a flattening equal to or smaller than 0.01 where a slit height represents a clearance of the nozzle slit outlet, the nozzle slit outlet width represents a chord of the arc, and the flattening represents a ratio of the slit height to the nozzle slit outlet width.

### BACKGROUND OF THE INVENTION

1. Field of the Invention

The invention relates to an art of a coating nozzle for spraying a coating body with a high-viscosity paint.

2. Description of Related Art

A coating nozzle for spraying a coating body with a high-viscosity paint (an acrylic resin paint, a polyester resin paint, a urethane resin paint, an epoxy resin paint, a melamine resin paint or the like) is known. In automobile manufacturing plants, a vehicle body or the like of an automobile is sprayed with a high-viscosity paint designed for the purposes of rust prevention, waterproofness, vibration damping and the like, using a coating nozzle mounted on a robot or the like. In Japanese Patent Application Publication No. 11-179243 (JP-A-11-179243), there is described a coating nozzle that supplies a paint from an introduction passage to an inner space, temporarily stores the paint in the inner space, and sprays a coating body with the paint from a nozzle slit in a radial direction.

However, in the case where coating is carried out using the coating nozzle described in Japanese Patent Application Publication No. 11-179243 (JP-A-11-179243), inhomogeneous concavities and convexities (wrinkles) may be formed on a coating surface after coating. It is possible to mention, as a cause for this, that a coating film is temporarily so formed as to stack in a height direction (a direction of the coating film perpendicular to the coating surface) in the vicinity of the coating body, that the coating film formed perpendicularly to the coating surface inhomogeneously tumbles in a traveling direction of the nozzle, and that the coating film, which has inhomogeneously tumbled, forms inhomogeneous concavities and convexities on the coating surface.

These concavities and convexities on the coating surface leave air gaps between the surface of the coating body and the paint, thus constituting a factor in a decrease in the adhesive force between the coating body and the paint. Further, the thickness of the coating film unnecessarily increases due to the concavities and convexities of the coating surface. In some cases, therefore, a coated component interferes with other components.

### SUMMARY OF THE INVENTION

The invention provides a coating nozzle for a high-viscosity paint which can smoothen a coating surface.

An aspect of the invention relates to a coating nozzle for a high-viscosity paint that is equipped sequentially with an introduction passage, an inner space, and a nozzle slit, which communicate with one another, supplies the high-viscosity paint to the inner space from the introduction passage, stores the high-viscosity paint in the inner space, and discharges the stored high-viscosity paint from the nozzle slit in a radial direction to spray a coating body with the high-viscosity paint. The nozzle slit is constructed in a sectional shape having a predetermined central angle and a width thereof increasing from the inner space side toward the high-viscosity paint discharging side. A region of the nozzle slit where it corresponds to an arc of the sectional shape serves as a nozzle slit outlet. The nozzle slit outlet has a nozzle slit outlet width equal to or larger than 35 mm and a flattening equal to or smaller than 0.01 where a nozzle slit height represents a clearance of the nozzle slit outlet, the nozzle slit outlet width represents a chord of the arc, and the flattening represents a ratio of the nozzle slit height to the nozzle slit outlet width.

In the foregoing aspect of the invention, the central angle may be equal to or larger than 80°.

In the foregoing aspect of the invention, the central angle may be 80°, the nozzle slit outlet width may be 39 mm, the nozzle slit height may be 0.4 mm, and the flattening may be 0.01.

In the foregoing aspect of the invention, the nozzle slit may be the only nozzle slit.

In the foregoing aspect of the invention, the nozzle slit may be provided in plural.

In the foregoing aspect of the invention, the nozzle slits may be formed parallel to one another.

In the foregoing aspect of the invention, the coating body may be sprayed with the high-viscosity paint first through one of the nozzle slits.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a constructional view showing an overall construction of a coating installation according to the embodiments of the invention;

FIG. 2 is also a constructional view showing an overall construction of a coating nozzle;

FIG. 3A is a plan view of a coating nozzle according to the first embodiment of the invention;

FIG. 3B is a front view of the coating nozzle according to the first embodiment of the invention;

FIG. 3C is a cross-sectional view of the coating nozzle according to the first embodiment of the invention taken along a line S1-S1 of FIG. 3A;

FIG. 4A is a cross-sectional view showing an irregular state of a coating film in a case where the coating nozzle according to the first embodiment of the invention is used;

FIG. 4B is a cross-sectional view showing an irregular state of a coating film in a case where a common coating nozzle is used;

FIG. 5A is a plan view of a coating nozzle according to the second embodiment of the invention;

FIG. 5B is a front view of the coating nozzle according to the second embodiment of the invention; and

FIG. 5C is a cross-sectional view of the coating nozzle according to the second embodiment of the invention taken along a line S2-S2 of FIG. 5A.

### DETAILED DESCRIPTION OF EMBODIMENTS

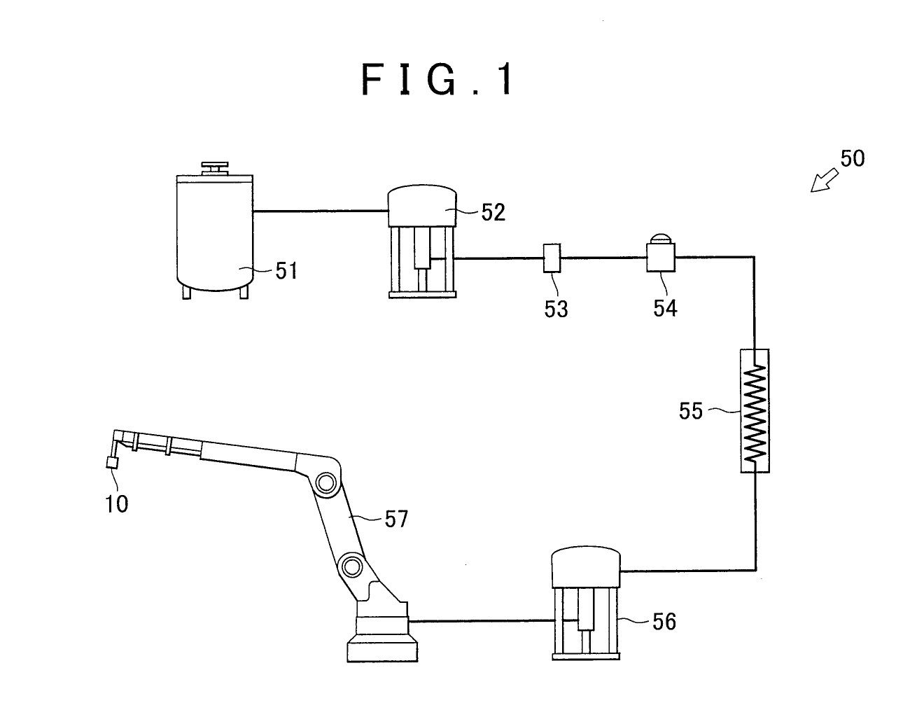

A coating installation 50 according to the first embodiment of the invention will be described using FIG. 1. The coating installation 50 is installed in a paint plant for automobiles. The coating installation quantitatively sprays a vehicle body 70 of an automobile with a high-viscosity paint (hereinafter referred to as a paint P). The coating installation 50 is equipped with a material container 51, a plunger pump 52, a filter 53, a regulator 54, a heat exchanger 55, a metering pump 56, a robot arm 57, and a coating nozzle 10. It should be noted that the paint P sprayed by the coating installation 50 may be another high-viscosity paint such as an acrylic resin paint, a polyester resin paint, an epoxy resin paint, a melamine resin paint, or the like.

The material container 51 stores the paint P therein. The plunger pump 52 fills the entire coating installation 50 with the paint P and force-feeds the paint P. The filter 53 removes foreign matters that have mixed into the paint P. The regulator 54 holds the pressure of the paint P in the coating installation 50 equal to an appropriate pressure. The heat exchanger 55 holds the temperature of the paint P in the coating installation 50 constant (25° C. in this embodiment of the invention). The metering pump 56 is driven by a servomotor to adjust the amount of the paint P discharged to the coating nozzle 10. The robot arm 57 moves the coating nozzle 10 freely with respect to the vehicle body 70. It should be noted that the coating nozzle 10 will be described later in detail.

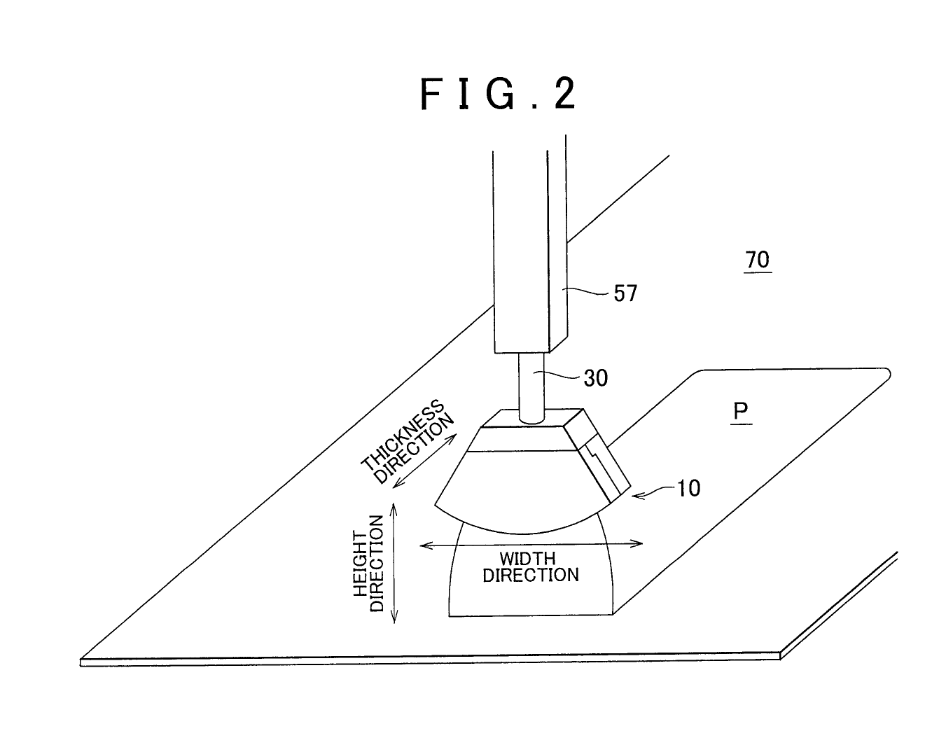

The coating nozzle 10 according to this embodiment of the invention will be described using FIG. 2. The coating nozzle 10 sprays the paint P supplied from an introduction duct 30 toward a surface of the vehicle body 70 radially in a width direction and in such a manner as to form a film with a constant thickness in a thickness direction. In a coating method for the paint P with the aid of the coating nozzle 10, while the coating nozzle 10 is slowly and linearly moved in the thickness direction thereof at a predetermined distance from the surface of the vehicle body 70 in a height direction, the paint P is discharged from the coating nozzle 10 and attached to the surface of the vehicle body 70. The vehicle body 70 is thus coated with the paint P. In the coating method employing the coating nozzle 10, the robot arm 57 is moved freely with respect to the vehicle body 70, thereby controlling the distance between the coating nozzle 10 and the surface of the vehicle body 70 and the coating position of the coating nozzle 10 on the surface of the vehicle body 70. Thus, coating can be carried out while changing a coating width, a coating film thickness, and the like.

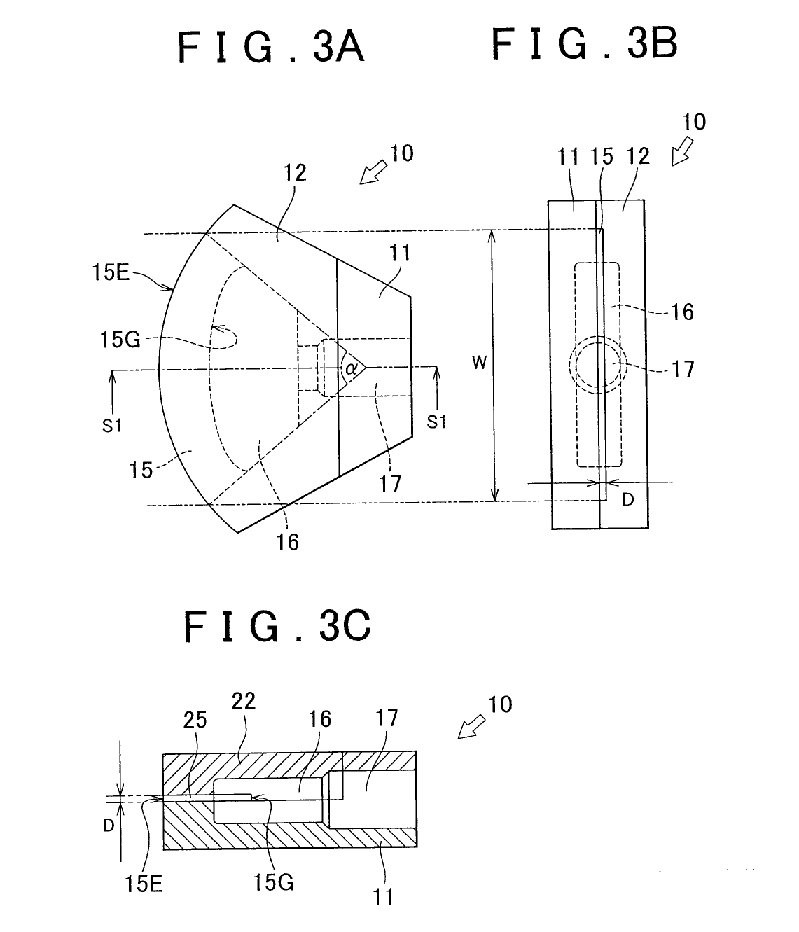

The coating nozzle 10 as the first embodiment of the invention will be described using FIGS. 3A to 3C. FIG. 3A is a plan view of the coating nozzle 10, FIG. 3B is a front view of the coating nozzle 10, and FIG. 3C is a cross-sectional view of the coating nozzle 10 taken along a line S1-S1 of FIG. 3A. The coating nozzle 10 is equipped with a main body 11 and a lid 12. The coating nozzle 10 is constituted by a thick plate-like member formed generally in the shape of a fan in a plan view. The main body 11 is formed generally in the shape of L with a rivet side thereof and a circular arc side thereof being thick and thin respectively in a lateral view. The lid 12 is formed as a flat plate supplementing a thin region of the main body 11 on the circular arc side thereof. That is, the lid 12 is attached to the thin region of the main body 11 on the circular arc side thereof, and the main body 11 and the lid 12 constitute the thick plate-like coating nozzle 10 as a whole. It should be noted that the main body 11 and the lid 12 are fixed to each other by a screw (not shown).

The coating nozzle 10 is equipped with a nozzle slit 15, an inner space 16, and an introduction passage 17. The nozzle slit 15, the inner space 16, and the introduction passage 17 are formed through the coating nozzle 10 such that the introduction passage 17, the inner space 16, and the nozzle slit 15 sequentially communicate with one another from the generally fan-shaped rivet side of the coating nozzle 10 toward the circular arc side thereof.

The nozzle slit 15 is formed through the generally fan-shaped coating nozzle 10 on the circular arc side thereof in a plan view. More specifically, the nozzle slit 15 is formed by sealing an opening face of a recess formed in the lid 12 of the coating nozzle 10 with the main body 11. The nozzle slit 15 is formed generally in the shape of a fan having a predetermined central angle in a plan view. The nozzle slit 15 is constructed as a slit equipped with a nozzle slit outlet 15E located on a discharge side of the paint P and a nozzle slit inlet 15G located on the inner space 16 side. That is, the nozzle slit 15 is constructed generally in the shape of a fan such that the width dimension of the nozzle slit 15 increases from the nozzle slit inlet 15G side toward the nozzle slit outlet 15E side. It should be noted herein that the central angle of the nozzle slit 15 formed generally in the shape of the fan is defined as an opening angle a.

The nozzle slit outlet 15E is a region corresponding to the circular arc of the generally fan-shaped nozzle slit 15. The nozzle slit outlet 15E has a slit height D as a nozzle slit height and a slit width W as a nozzle slit width. The slit height D is a dimension of the nozzle slit outlet 15E in the thickness direction of the coating nozzle 10 (a gap of the nozzle slit outlet 15E), and the slit width W is a dimension of the nozzle slit outlet 15E in the width direction of the coating nozzle 10. Further, the slit width W is a dimension of a region as a chord of a circular arc of the nozzle slit outlet 15E, which is formed in the shape of the circular arc in a plan view. It should be noted herein that the ratio of the slit height D to the slit width W is defined as a flattening F.

The nozzle slit inlet 15G is located at a boundary portion between the inner space 16, which is formed generally in the shape of a fan in a plan view, and the nozzle slit 15, and is a region corresponding to a circular arc of the generally fan-shaped inner space 16. The dimension of the nozzle slit inlet 15G in the thickness direction of the coating nozzle 10 is set equal to the same slit height D as that of the nozzle slit outlet 15E.

The inner space 16 is formed in the generally fan-shaped coating nozzle 10 substantially at the center thereof in a plan view. More specifically, the inner space 16 is composed of a recess formed in the main body of the coating nozzle 10 and the recess formed in the lid 12. The inner space 16 is formed generally in the shape of a fan having a predetermined central angle (an opening angle a) in a plan view. An end of the inner space 16, which is formed generally in the shape of the fan, on the nozzle slit 15 side is a region corresponding to the circular arc of the generally fan-shaped inner space 16. The dimension of the inner space 16 in the thickness direction of the coating nozzle 10 is set sufficiently larger than the slit height D.

The introduction passage 17 is formed on the rivet side of the coating nozzle 10, which is formed generally in the shape of the fan in a plan view. More specifically, the introduction passage 17 is constituted by the recesses formed in the main body of the coating nozzle 10 and the lid 12. The introduction passage 17 is formed generally in the shape of a circular cylinder.

It is particularly worth noting that the opening angle a is 80°, the slit width W is 39 mm, and the slit height D is 0.4 mm in the nozzle slit 15 of the coating nozzle 10 of the first embodiment of the invention. In this case, the flattening F is 0.01. It should be noted that, for example, the opening angle is 90°, the slit width is 43 mm, and the slit height is 0.6 mm in a common coating nozzle, and that the opening area of a nozzle slit outlet of the common coating nozzle is set larger than the opening area of the nozzle slit outlet 15E of the coating nozzle 10 in this first embodiment of the invention.

According to the coating nozzle 10 of this first embodiment of the invention, since the slit width W is 39 mm, the slit height D is 0.4 mm, and the flattening F is 0.01, the opening area of the nozzle slit outlet 15E is smaller than in the case of the conventional coating nozzle. Thus, a mesh size of the aforementioned filter 53 is selected as a size equal to or larger than the slit height D, namely, 0.4 mm. The plunger pump 52 and the metering pump 56 are selected in consideration of a decrease in the opening area or a pressure loss resulting from a selection of the filter.

The operation common to the coating nozzle 10 of the first embodiment of the invention and the common coating nozzle will be described. As regards the thickness direction, the width direction, and the height direction, the following description will be given referring to the directions shown in FIG. 2. The paint P is delivered from the metering pump 56 of the coating installation 50 to the introduction passage 17 of the coating nozzle 10 at a predetermined pressure. The paint P delivered to the introduction passage 17 is supplied to the inner space 16. The supplied paint P is temporarily stored in the inner space 16. In this case, the paint P is once discharged to the inner space 16, which is more spacious than the introduction passage 17, so that the deflection of the internal pressure caused in the paint P is homogenized.

The paint P is then extruded from the inner space 16 to the nozzle slit inlet 15G The paint P thrust into the nozzle slit inlet 15G is discharged from the nozzle slit outlet 15E via the nozzle slit 15, and is sprayed toward the vehicle body 70. The paint P sprayed on the vehicle body 70 is discharged while spreading radially from the nozzle slit outlet 15E in the width direction and being formed in the shape of a film with a constant thickness in the thickness direction, and adheres to the surface of the vehicle body 70.

The operation and effect peculiar to the coating nozzle 10 of the first embodiment of the invention will be described. In the case where the surface of the vehicle body 70 is sprayed with the paint P by the common coating nozzle, the coating film is temporarily so formed as to stack in the height direction (in the direction of the coating film perpendicular to the coating surface) in the vicinity of the vehicle body 70, and the coating film formed perpendicularly to the coating surface inhomogeneously tumbles in the moving direction of the coating nozzle (the thickness direction of the coating nozzle). The coating film, which has inhomogeneously tumbled, may form inhomogeneous concavities and convexities on the surface of the vehicle body 70.

According to the coating nozzle 10 of this first embodiment of the invention, the slit width W is 39 mm, the slit height D is 0.4 mm, and the flattening F is 0.01. Therefore, the opening area of the nozzle slit outlet 15E is smaller than in the case of the common coating nozzle. Thus, given that the same amount of the paint P is sprayed (discharged) per unit time, the flow velocity of the paint P in the vicinity of the vehicle body 70 in the case where the coating nozzle 10 of this first embodiment of the invention is used is higher than the flow velocity of the paint P in the case where the common coating nozzle is used. Then, owing to the high flow velocity of the paint P in the vicinity of the vehicle body 70, the coating film applied to the surface of the vehicle body 70 is crushed by the paint discharged from the coating nozzle 10, and is restrained from growing in the height direction (in the direction of the coating film perpendicular to the coating surface). Accordingly, the amplitude and wavelength of inhomogeneous concavities and convexities can be reduced, the creation of inhomogeneous concavities and convexities can be suppressed, and the coating surface of the vehicle body 70 can be smoothened.

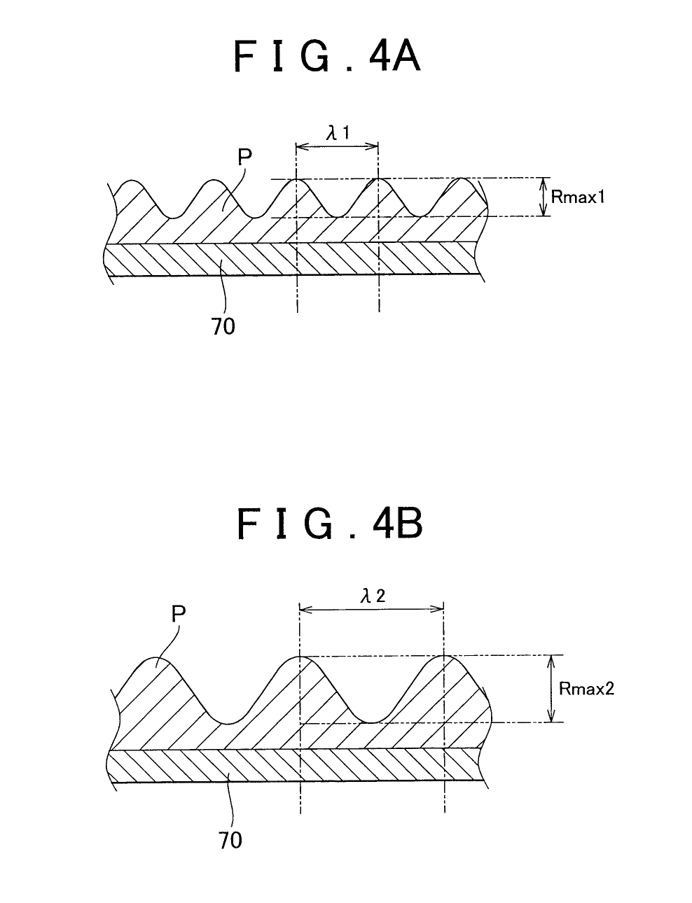

For example, as shown in FIGS. 4A and 4B, an amplitude Rmax1 and a wavelength λ1 (see FIG. 4A) of the concavities and convexities on the coating film in the case where the coating nozzle 10 of this first embodiment of the invention is used can be made smaller than an amplitude Rmax2 and a wavelength λ2 (see FIG. 4B) of the concavities and convexities on the coating film of the paint P sprayed on the vehicle body 70 in the case where the common coating nozzle is used, respectively. That is, it is possible to ensure that Rmax1<Rmax2 and λ1<λ2.

Further, in a high-viscosity paint, there is generally a correlation between viscosity and shearing speed. The viscosity increases as the shearing speed falls, and the viscosity decreases as the shearing speed rises. In this case, on the assumption that the flow velocity and the shearing speed border on each other, the viscosity decreases as the flow velocity rises. That is, since the flow velocity of the paint P in the vicinity of the vehicle body 70 in the case where the coating nozzle 10 of this first embodiment of the invention is used is higher than the flow velocity of the paint P in the case where the common coating nozzle is used, the viscosity is low. Thus, the paint P is sprayed on the vehicle body 70 with low viscosity, and is increased in fluidity on the surface of the vehicle body 70. Therefore, the coating surface of the vehicle body 70 can further be smoothened.

In the case where spraying is carried out with the aid of the coating nozzle, since a large coating width (a large dimension in the width direction) is desired, the opening angle a of the generally fan-shaped region of the coating nozzle is set equal to 90°. The flow velocity of the paint P in the vicinity of the vehicle body 70 in the case where the coating nozzle 10 of this first embodiment of the invention is used is higher than the flow velocity of the paint P in the case where the conventional coating nozzle is used. Thus, the paint P blown out from the coating nozzle 10 has a high speed component in the width direction as well. When the opening angle a of the coating nozzle 10 is set equal to the same angle as that of the conventional coating nozzle, the coating width is unnecessarily wide. Thus, according to the coating nozzle 10 of the first embodiment of the invention, the opening angle a of the nozzle slit 15 is set equal to 80°, thus making it possible to restrain the coating width from becoming unnecessarily wide when the paint P is blown out by the coating nozzle 10.

At the same time, the speed component of the paint P blown out from the coating nozzle 10 in the height direction can be made high. The coating film with which the surface of the vehicle body 70 is coated is crushed by the paint P blown out from the coating nozzle 10, and is restrained from growing to be formed in the height direction. Accordingly, concavities and convexities can be restrained from being unnecessarily formed on the surface of the coating film, and the coating surface of the vehicle body 70 can be smoothened.

In this manner, according to the coating nozzle 10 of the first embodiment of the invention, the coating surface of the vehicle body 70 can be smoothened.

It should be noted that although the opening angle a is 80°, the slit width W is 39 mm, the slit height D is 0.4 mm, and the flattening F is 0.01 as to the nozzle slit 15 in the coating nozzle 10 of the first embodiment of the invention, a similar operation and a similar effect are obtained when the opening angle a is made equal to or larger than 80°, the slit width W is made equal to or larger than 35 mm, and the flattening F is made equal to or smaller than 0.01.

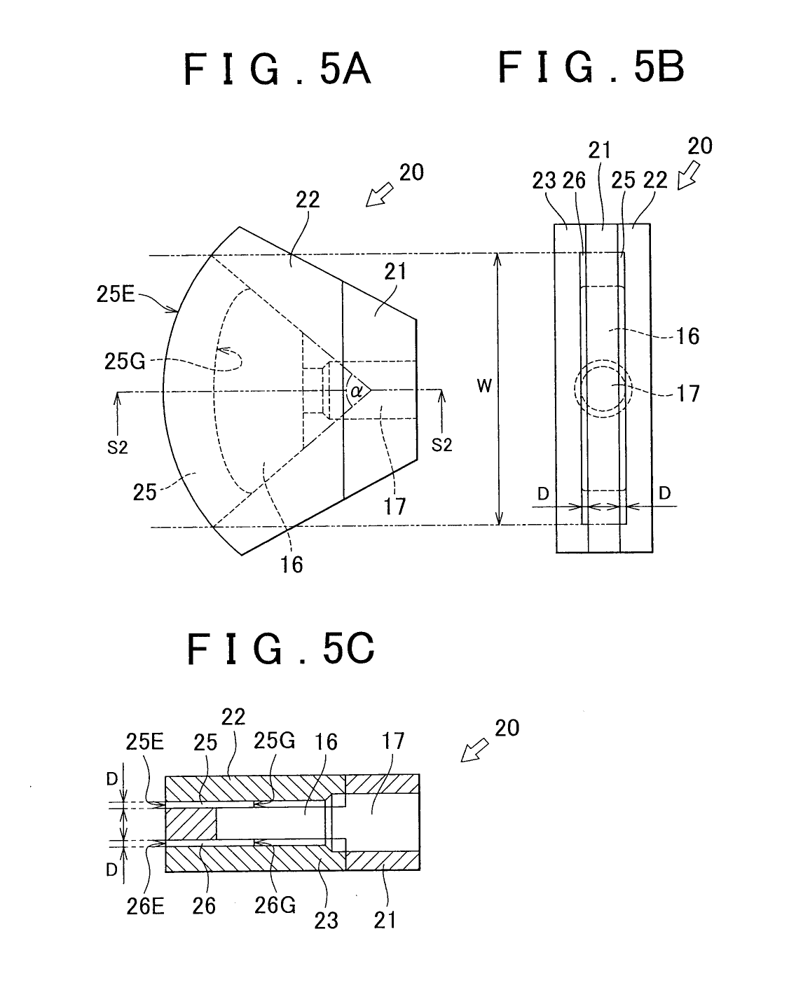

A coating nozzle 20 as the second embodiment of the invention will be described using FIGS. 5A to 5C. FIG. 5A is a plan view of the coating nozzle 20, FIG. 5B is a front view of the coating nozzle 20, and FIG. 5C is a cross-sectional view of the coating nozzle 20 taken along a line S2-S2 of FIG. 5A. The coating nozzle 20 is equipped with a main body 21, a lid 22, and a lid 23. The coating nozzle 20 is constituted by a thick plate-like member formed generally in the shape of a fan in a plan view. The main body 21 is generally formed in the shape of T with a rivet side being thick and a front side and a back side on a circular arc side being thin in a lateral view. The lid 22 and the lid 23 are formed as flat plates supplementing a thin region of the main body 21 on the circular arc side thereof. That is, the lids 22 and 23 are attached to the front side and back side of the thin region of the main body 21 on the circular arc side thereof respectively, and the main body 21 and the lids 22 and 23 constitute the thick plate-like coating nozzle 20 as a whole. It should be noted that the main body 21 and the lids 22 and 23 are fixed to one another by screws (not shown).

The coating nozzle 20 is equipped with two nozzle slits 25 and 26, the inner space 16, and the introduction passage 17. The nozzle slits 25 and 26, the inner space 16, and the introduction passage 17 are formed through the coating nozzle 20 such that the introduction passage 17, the inner space 16, and the nozzle slits 25 and 26 sequentially communicate with one another from the rivet side toward the circular arc side of the generally fan-shaped region of the coating nozzle 20. Further, the nozzle slits 25 and 26 are arranged in a state of being laminated on each other in the thickness direction of the coating nozzle 20.

The nozzle slits 25 and 26 are formed through the generally fan-shaped coating nozzle 20 on the circular arc side thereof in a plan view. More specifically, the nozzle slit 25 is formed by sealing an opening face of a recess formed in the lid 22 with the main body 21, and the nozzle slit 26 is formed by sealing an opening face of a recess formed in the lid 23 with the main body 21. The nozzle slits 25 and 26 are formed in the same shape, and are so formed through the coating nozzle 20 as to extend parallel to each other in a lateral view.

As regards the inner space 16, the introduction passage 17, and the nozzle slits 25 and 26, nozzle slit outlets 25E and 26E, nozzle slit inlets 25G and 26G, the opening angle a, the slit height D, the slit width W, and the flattening F are the same as in the coating nozzle 10 of the first embodiment of the invention and hence will not be described below. Further, as is also the case with the nozzle slit 15 of the first embodiment of the invention, the opening angle a is 80°, the slit width W is 39 mm, the slit height D is 0.4 mm, and the flattening F is 0.01 as to the nozzle slits 25 and 26.

The operation of the coating nozzle 20 of the second embodiment of the invention will be described. According to the coating nozzle 20 of the second embodiment of the invention, the opening area of the nozzle slit outlets 25E and 26E is made smaller than in the case of the common coating nozzle. Therefore, the flow velocity of the paint P in the vicinity of the vehicle body 70 is higher than in the case of the common coating nozzle. Thus, as is the case with the coating nozzle 10 of the first embodiment of the invention, the coating film on the surface of the vehicle body 70 is crushed, and the coating film is restrained from being temporarily formed in the height direction.

In addition to this point, according to the coating nozzle 20 of the second embodiment of the invention, the concavities and convexities created on the coating surface are mutually counterbalanced by the paint P blown out from the nozzle slit outlets 25E and 26E at a plurality of locations, so that the coating surface can be smoothened. Further, if the nozzle slit 25 precedes the other nozzle slit 26 (the nozzle slit 25 is located in front of the other nozzle slit 26 in the moving direction of the coating nozzle 20), the paint applied after being blown out from the nozzle slit 25 is crushed by the paint blown out from the nozzle slit 26, which follows the nozzle slit 25, in the moving direction of the coating nozzle 20. Therefore, the adhesive force of the paint P to the vehicle body 70 can be increased.

In this manner, according to the coating nozzle 20 of the second embodiment of the invention, the coating surface of the vehicle body 70 can be smoothened. Further, the adhesive force of the paint P to the vehicle body 70 can be increased.

While the invention has been described with reference to the example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1. (canceled)

2. The coating nozzle for the high-viscosity paint according to claim 8, wherein the central angle is equal to or larger than 80□.

3. The coating nozzle for the high-viscosity paint according to claim 2, wherein the central angle is 80°, the nozzle slit outlet width is 39 mm, the nozzle slit height is 0.4 mm, and the flattening is 0.01.

4. The coating nozzle for the high-viscosity paint according to claim 8, wherein the nozzle slit is the only nozzle slit.

5. The coating nozzle for the high-viscosity paint according to claim 8, wherein the nozzle slit is provided in plural.

6. The coating nozzle for the high-viscosity paint according to claim 5, wherein the nozzle slits are formed parallel to one another.

7. The coating nozzle for the high-viscosity paint according to claim 5, wherein the coating body is sprayed with the high-viscosity paint first through one of the nozzle slits.

8. A coating nozzle for a high-viscosity paint comprising:
an introduction passage;
an inner space; and
a nozzle slit,
wherein the introduction passage, the inner space, and the nozzle slit, which communicate with one another, are sequentially formed,
wherein the coating nozzle supplies the high-viscosity paint to the inner space from the introduction passage, stores the high-viscosity paint in the inner space, and discharges the stored high-viscosity paint from the nozzle slit in a radial direction to spray a coating body with the high-viscosity paint,
wherein the nozzle slit is constructed in a sectional shape having a predetermined central angle and a width thereof increasing from the inner space side toward the high-viscosity paint discharging side,
wherein a region of the nozzle slit where it corresponds to an arc of the sectional shape serves as a nozzle slit outlet, and
wherein the nozzle slit outlet has a nozzle slit outlet width equal to or larger than 35 mm and a flattening equal to or smaller than 0.01 where a nozzle slit height represents a clearance of the nozzle slit outlet, the nozzle slit outlet width represents a chord of the arc, and the flattening represents a ratio of the nozzle slit height to the nozzle slit outlet width.
